(19) United States
(12) Patent Application Publication
(10) Pub. No.: US 2006/0265727 A1
(43) Pub. Date: Nov. 23, 2006

(54) Icon retrieval and display

(76) Inventor: Larri Vermola, Turku (FI)

Correspondence Address: HARRINGTON & SMITH, LLP, 4 RESEARCH DRIVE, SHELTON, CT, 06484-6212, US

(21) Appl. No.: 10/557,871

(22) PCT Filed: Jun. 30, 2004
(86) PCT No.: PCT/IB04/51056

§ 371 Date: Nov. 18, 2005

(30) Foreign Application Priority Data
Jun. 30, 2003 (GB) 0315267.5

(51) Int. Cl. H04N 5/445

(52) U.S. Cl. 725/56; 725/44

(57) ABSTRACT

A mobile device operates following a user input indicating that a service guide is required to be displayed to retrieve from a user preferences database storage area required ESG data fields. The ESG data fields might be the start time and the end time of the service, for example. At step 22, the mobile device retrieves from an icon data storage area displayable icons corresponding to the services listed in the ESG data storage area which are to be displayed on a display. This includes reading data from the ESG data storage area, identifying the services information concerning which can be displayed on the display, determining what content descriptors correspond to those services, for each content descriptor looking up the corresponding icon in the icon data storage area, and retrieving those icons. At step 23, the data from the data fields found in step 21 is displayed for each of the selected services, and alongside each of the services is displayed the corresponding icon. In this way, for each service an icon is displayed alongside which indicates the service type e.g. film, current affairs etc. without the icon data being transmitted over-the-air. This allows the user to determine quickly and accurately what kind of service type the service relates to. A user may then select, by way of an input 24, a service displayed on the display. The mobile device then initiates at step 26 consumption of the content of the service which relates to the ESG data Other icons instead relate to individual services or service providers, and such icons may be prioritised over service type icons.

This invention relates to a mobile device, and to a method of operating a mobile device. The invention is concerned with retrieving an icon for displaying with service guide data.

The present invention is applicable to mobile telecommunication networks involving the delivery of digital services to wireless mobile terminals, the digital services being accessible through an user interface that can be implemented as a list of content items in mobile portal, electronic service guide or other similar user interface.

The deployment of advanced high bit-rate mobile networks has opened up new opportunities for delivering a host of services in a way that was not possible with earlier second generation wireless networks. Third generation systems such as Universal Mobile Telephone Service (UMTS) or lower bit-rate systems such as High Speed Circuit Switched Data (HSCSD) and General Packet Radio Service (GPRS) specified for use with the Global System for Mobile Communications (GSM) wireless standard, are able to provide the delivery of new digital services such as video calls and the playback of multimedia applications that are comprised of audio and video clips. Other content formats like applications, games, electronic magazines and newspapers etc. can also be conveniently delivered and consumed.

The development of high-speed networks and the wide variation of different content formats that it is possible to deliver to mobile terminals provide some opportunities to reshape the way in which the different media content can be combined, delivered and consumed. The location and selecting of the content that a user is interested in is becoming more difficult as the amount of content increases and as the content types merge in terminals. Furthermore, for terminals with a limited size of display, it can be difficult to provide a user-friendly way of showing the available services to users.

According to a first aspect of the invention there is provided a method of operating a mobile device, the method comprising receiving service guide information, extracting a data item for a service from service guide data relating to the service and included in the service guide information, using the data item to retrieve from memory a pre-existing identifier associated with the data item and rendering the identifier along with at least some of the service guide data for the service. The identifier may be one or more of the following: an icon, a figure, a picture, a graphical symbol, an animation, a textual string, an audible signal or any other user-recognizable feature that can be rendered by a suitable rendering means to be presented to the user.

The data item may be a content descriptor, or a service identifier. A service identifier may uniquely identify a service provider, and relate to a number of services.

The invention allows the identifier indicating the type of service to be rendered alongside some data describing the service without requiring the broadcast of data constituting the identifier over a network, at least not along with the service guide information nor the service content itself. The invention can also allow a user of the mobile device to be presented with information allowing easy identification of the content associated with a particular service or with the service itself, for example non-textually. The advantages obtainable by having the identifier pre-existing in memory depends on the amount of data which is required to describe the identifier and on the number of occasions on which the identifier data would otherwise need to have been communicated to the mobile device. A maximum advantage can be obtained if the identifier is pre-installed on the mobile terminal, for example, during programming by the manufacturer, or during programming by a vendor. However, advantages can also be obtained if the identifier data is broadcast occasionally, in which case the mobile device need only receive the identifier once, since then it can have the identifier stored in memory. Alternatively, the identifier could be stored in a volatile memory, in which the case the mobile device might need to receive the identifier following each occasion of power-up. In such an embodiment, it might be desirable to arrange for the identifier to be broadcast over the network on an increased periodic basis or, alternatively, for the identifier to be delivered directly to the mobile device on a point-to-point link, for example using GPRS or HSCSD.

Preferably, the using step involves comparing the data item with a descriptor stored with the identifier, and retrieving the identifier if there is an identicality. Storing with the identifiers, the same identifier descriptors that are broadcast or transmitted as part of the service guide information provides a particularly convenient arrangement, and can allow rapid and accurate identifier retrieval.

Preferably, the method comprises allowing a user to define what fields of the service guide data are displayed with the identifier.

The method preferably comprises storing in memory a user preference database, each of one or more entries in the user preference database linking a selectable preference with one or more content descriptors. This can allow services from the service guide to be filtered by way of their associated content descriptor. Preferably, the method comprises, in response to the selection by a user of a selectable preference, displaying service guide data relating only to services having one of the corresponding one or more content descriptors. Thus, a user can arrange for the mobile device to display only services which relate to the service type or types of interest to the user.

The identifier may be pre-installed on the mobile device, or it might be received separately of the service guide information. One or more identifiers may be downloaded to the mobile device from one or more sources, to which the mobile device has access and to which it may be connected. In addition to or instead of the broadcast network the source for downloading one or more identifiers may be other networks or devices with which the mobile device may communicate wirelessly or by using a wired connection. Such communication comprises short-range wireless communication such as e.g. a Bluetooth connection. Further the user may create himself one or more identifiers and/or modify some of the downloaded and/or stored identifiers. A different identifier may be provided for each service type, as defined by the content descriptor, or for each service or service provider as defined by a service identifier.

The method preferably further comprises, in response to the selection by a user of an identifier or service guide data relating to a service, initiating consumption of content associated with the service. This provides a particularly convenient way to access content identified by the identifier and service guide data, in a user-friendly manner.

According to a second aspect of the invention, there is provided a mobile device, comprising a store for storing service guide information, an extractor for extracting a data item for a service from service guide data relating to the service and included in the service guide information, a retriever for using the data item to retrieve from memory a pre-existing identifier associated with the data item and a renderer for rendering the identifier along with at least some of the service guide data for the service.

In DVB standard ETSI EN 300 468 V1.5.1 (2003-01) Digital Video Broadcasting (DVB); Specification for Service Information (SI) in DVB systems, which is incorporated herein for reference, specifically in Table 28, content descriptors are defined for use in the Service Information (SI) tables. These content descriptors may be used as such or as a basis for the content descriptors of the present invention.

Embodiments of the present invention will now be described, by way of example only, with reference to the accompanying drawings, in which:

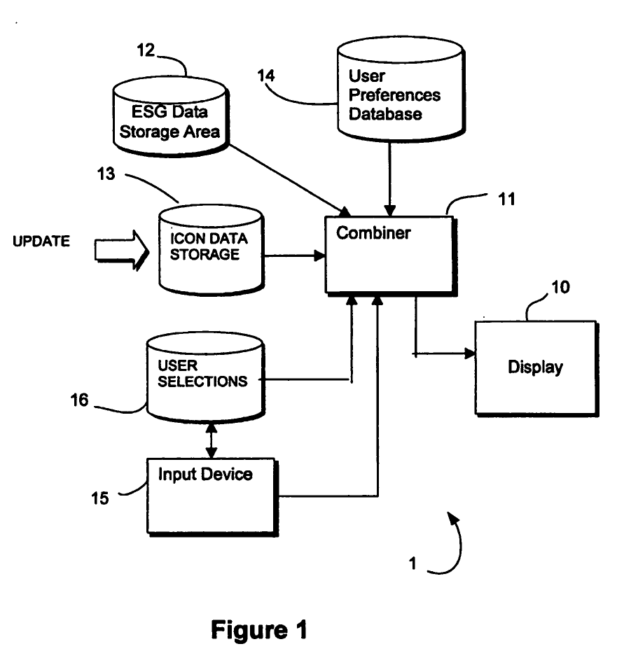

FIG. 1 illustrates certain components of a mobile device according to one aspect of the invention and operating according to another aspect;

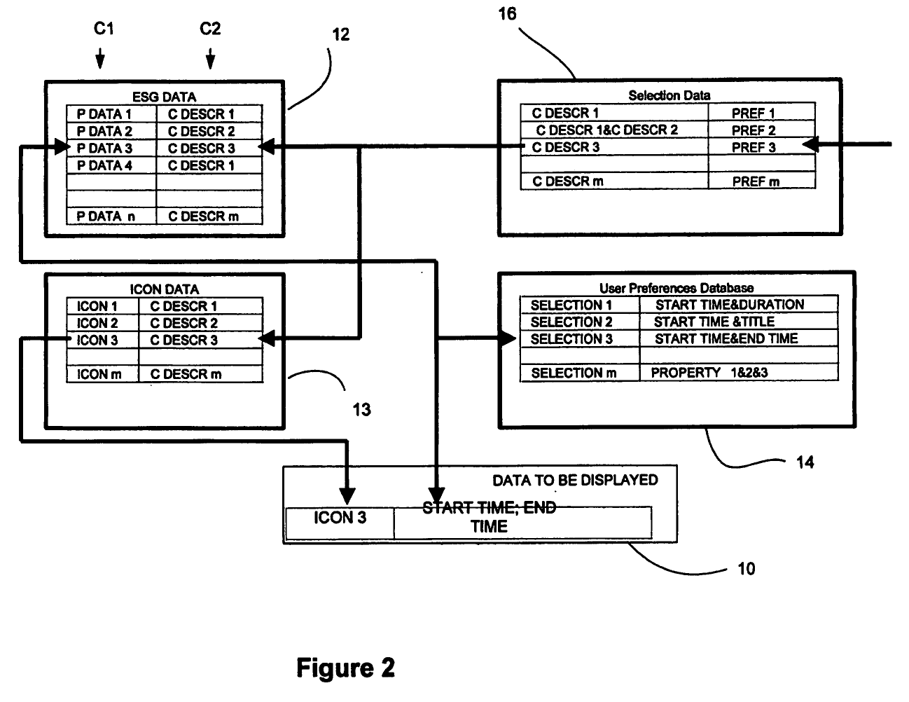

FIG. 2 illustrates certain databases stored within the mobile device of FIG. 1;

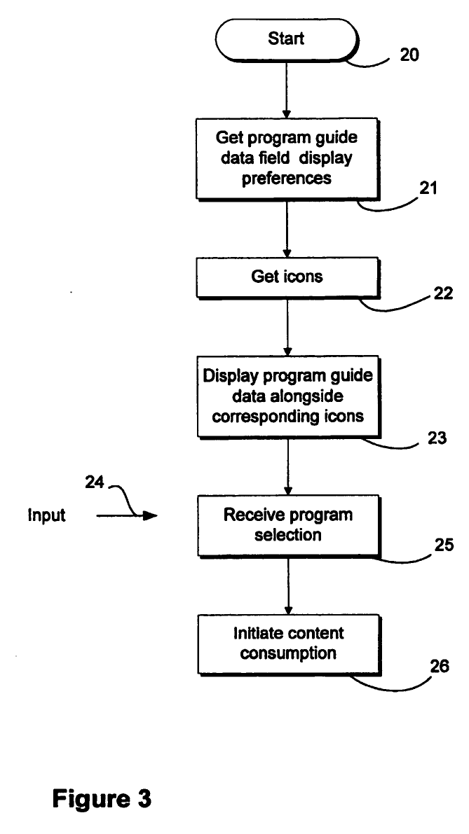

FIG. 3 is a flow diagram illustrating operation of the mobile device of FIG. 1 in displaying data from a service and for arranging for the initiation of content consumption;

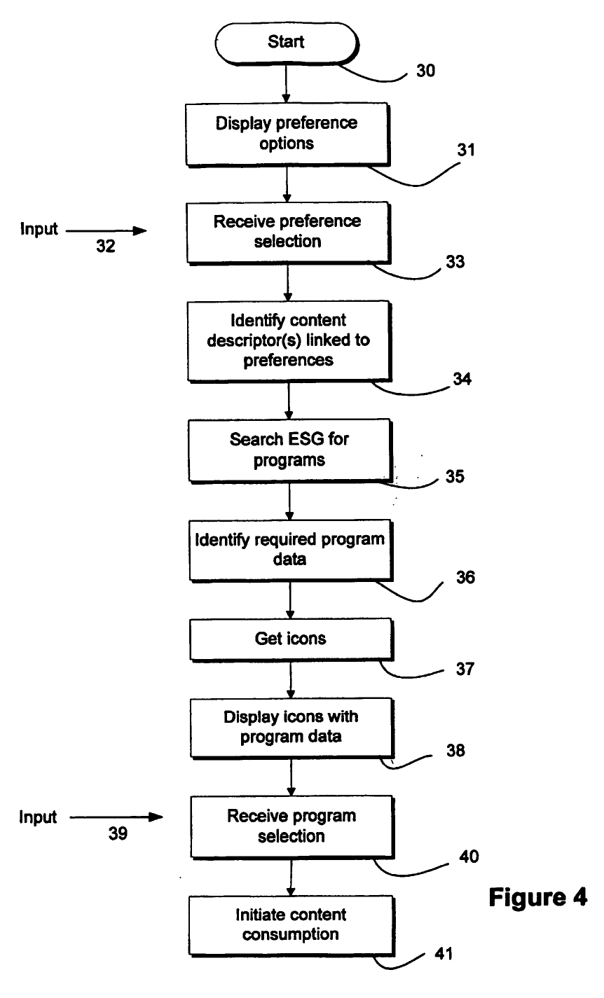

FIG. 4 is a flow diagram illustrating the initiation of content consumption from a list of services of a type or types selected as preferred service types by a user;

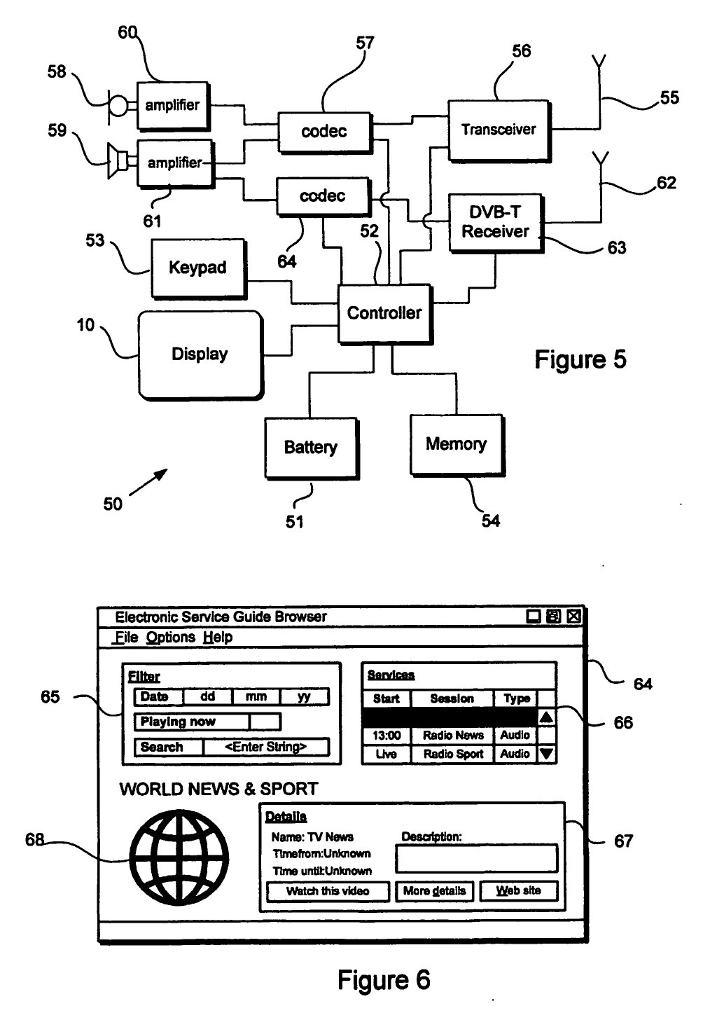

FIG. 5 is a schematic illustration of a mobile telecommunications device for performing a method according to the invention; and

FIG. 6 is an illustration of an ESG browser display on the device of FIG. 4.

Referring to FIG. 1, the mobile device 1 is illustrated schematically comprising generally a display 10, which is fed with data by a combiner 11, for example a micro-controller in the mobile device, as will be described in more detail later. In this example the display 10 displays identifiers in the form of icons, but the invention is not limited to icons, as will be evident hereinafter. The combiner 11 takes input from each of an electronic service guide (ESG) or electronic program guide (EPG) data storage area 12, an icon data storage area 13, a user display preference database storage area 14, an input device 15 and a user selection database area 16 containing user content preferences. The input device 15 also is connected to the user selection database area 16.

The mobile device 1 could take any form. In a preferred embodiment, the mobile device is a 3G mobile telephone provided with broadcast receiving and decoding capabilities including capabilities for Internet Protocol Data Casting (IPDC) receiving and decoding. However, it may instead take any other suitable form, for example omitting mobile telephony functionality or including instead second generation mobile telephony capabilities or mobile telephony equipment of any other form. The mobile device 1 may be a laptop or notebook computer or any other easily portable device. It is preferred that the mobile device 1 is hand-held, i.e. able to be held in one hand and operated easily with the same or another hand.

In addition to the networks mentioned above, digital broadcasting networks such as e.g. Terrestrial Digital Video Broadcasting system (DVB-T) or the like, a digital broadband broadcast network as defined by the Advanced Television Systems Committee (ATSC) or the Integrated Services Digital Broadcasting (ISDB) network may be used for providing Internet Protocol Data Casting (IPDC) services. The ability to decode data from an IPDC transmission depends on a subscription to that service. In order to achieve reduced power consumption in the receiver of the mobile devices, the transmission of services is carried out in bursts, utilising the whole of the channel bandwidth, rather than multiplexing them in any other way. This is known as time-slicing. The ESG data is received in bursts in a channel to which the receiver of the mobile device is tuned, and the ESG data received in one or more bursts in that channel is stored in the storage area 12 of mobile device, with the receiver being turned off between the end of receiving one burst received and the start of receiving the next burst. The ESG received in this way can then be displayed on the display 10.

The data storage areas of the mobile device of FIG. 1 are shown in more detail in FIG. 2. Here, it will be seen that the ESG data storage area 12 comprises a database consisting of a first column C1, each cell of the column containing data relating to a different service. In a second column C2, a content descriptor associated with the corresponding service is stored. The content descriptors may accord with the aforementioned DVB standard ETSI EN 300 468 V1.5.1 (2003-01). The ESG data is received over the air alongside content transmitted over e.g. the DVB network (not shown). The ESG data can be termed meta data since it is data describing data. The ESG data is entirely conventional and includes, for example, the service tide, a start time, end time, duration and a content descriptor. The content descriptor can also be described as service type information, since it indicates the type of content the service relates to. Some service types include movie, current affairs, sports, children's, music, culture, factual topics, adult entertainment, downloadable games, chat, application programs, printed media, teletext and online and offline web content. The content descriptor may also relate to an undefined service type. The way in which the ESG data storage area 12 is populated with ESG data may be entirely conventional. The ESG data may also be received in any other suitable manner, for example, using GPRS, HSCSD, WAP or the like. The nature and frequency of transmission of the ESG data may depend on whether the DVB broadcasting operator has a service portfolio, which consists of predetermined or of dynamically changing service times.

In this example the identifiers for service types are icons. The icon data storage area 13 contains for each different service type (i.e. for each different content descriptor) an icon which comprises data usable to form an image. The image is preferably somehow related to the corresponding service type. For example, the icon relating to a service type “movie” could contain an image of a cinema projector and an icon relating to “World News and Sport” could contain an image including a globe. The exact depiction provided by the icons is not relevant to the invention, so is not described in any further detail here. Also, the data can take any suitable format, for example, a bitmap, a Graphics Interchange Format (GIF) file or other.

The user selection database area 16 contains a number of user content preferences. These preferences are user-definable, although it may be that certain default preferences are pre-installed in the mobile device before sale. The preferences may instead be defined by a service provider, and received over-the-air. A first preference PREF 1 is shown as corresponding to content descriptor number one C DESCR 1, and a second preference PREF 2 is shown as relating to content descriptors numbers one and two Le. C DESCR 1 & C DESCR 2. The user selection database area 16 may contain any suitable number of user selectable preferences. Details of the preferences will be understood after reading the explanation of their use below.

The user display preferences database storage area 14 contains a number of ESG data presentation user preferences for controlling the manner in which data about available services is displayed on the display device 10. For example, a first selection (SELECTION 1) indicates that the required ESG data is the start time of the service and the duration of the service. A second selection (SELECTION 2) indicates that the preferences are for the start time and for the tide service. A third selection (SELECTION 3) indicates that the required ESG data is the start time and end time of the service. Various combinations of the ESG data fields can be included in other selections. The data populating the database storage area 14 is user definable, although certain selections may be preinstalled onto the mobile device 1 before sale or at the instant of purchase, wherein the user may specify and/or select one or more preinstalled selections. The number of data fields contained in a selection may differ from the two fields in the examples above. The number of fields might depend on the physical size of the display 10.

In FIG. 2, the display 10 is illustrated as showing an icon alongside certain ESG data.

Operation of the mobile device 1 to display the ESG data in a first, relatively simple manner will now be described with reference to FIG. 3. The operation begins at step 20, following a user input indicating that a service guide is required to be displayed on the display 10. At step 21, the mobile device 1 retrieves from the user preferences database storage area 14 the ESG data fields which relate to the currently selected selection. The selection will normally be made by a user at any suitable time, and need not normally be made at the time of requesting the ESG service be provided on the display 10. If a user has not made a selection, then a default selection may be used. In this example, the ESG data fields indicated by this selection are the start time and the end time of the service(s). At step 22, the mobile device 1 then retrieves from the icon data storage area 13 the displayable icons corresponding to the services listed in the ESG data storage area 12 which are to be displayed on the display 10. As previously mentioned, in this embodiment of the invention, icons are used as identifiers. This step includes reading data from the ESG data storage area 12, identifying the service information to be displayed on the display 10, determining what content descriptors correspond to those services, for each content descriptor looking up the corresponding icon in the icon data storage area 13, and retrieving those icons. At step 23, the data from the data fields found in step 21 is displayed for each of the identified services, and alongside each of the services is displayed the corresponding icon. In this way, for each service an icon is displayed alongside, such icon indicating the service type .e.g. film, current affairs etc. This is achieved without the icon data being transmitted along with the ESG data. Displaying the icon with the service guide data allows the user to determine quickly and accurately what service type the service relates to. In most circumstances, this information will be very helpful to the user in determining whether or not he or she is interested in the content of the service.

A user may then select, by way of an input 24, a service displayed on the display 10. If the user is not interested in any of the services immediately displayed, he or she may scroll up or down through the ESG data until a service of interest is found. The selection constituting the input 24 may involve the pressing of a “yes” button or the touching of a touch sensitive display, for example. The mobile device 1 receives the service selection at step 25, after which it initiates at step 26 consumption of the content of the service which relates to the ESG data.

Reference is now made to FIG. 4, which shows a second, more sophisticated way of retrieving an identifier such as an icon, for display with service guide data and then initiating the consumption of content for a service. In this example, the displayed data is filtered according to one of the user content preferences stored in the database area 16. Here the operation begins at step 30 on a selection by a user of one of the preference options that are included in the user selection database area 16. This may be initiated by selecting a menu option, which lists the various preferences PREF 1 etc., and by allowing a user to select one of them. As an example, the preferences may list something like “sport”, “movies”, “music and music videos”, etc. This is illustrated by the display of preference options at step 31 by the user input 32 and by the receive preference selection step 33. At step 34, the mobile device 1 identifies the content descriptor or content descriptors linked to the selected preference. This step involves examining the user selection database 16 and extracting the content descriptors which correspond to the selected preference. At step 35, the mobile device 1 then searches the ESG data for services which have the same content descriptor as that or those taken from the user selection database area 16. Services which have a corresponding content descriptor are selected from the other services. At step 36, the required service data is then identified. This involves examination of the user preferences database storage area 14 to determine what data fields from the ESG data are identified to be used in displaying service data, as is described above with reference to FIG. 3. Having determined the required data fields, the ESG data storage area 12 is then examined to extract the relevant data for the services which have the correct content descriptor. The icon or icons relating to these services are then retrieved from the icon data storage area 13 at step 37, in a similar manner to that described above with reference to FIG. 3. At step 38, the mobile device 1 then displays the extracted service data along with the corresponding icons on the display 10. A user may then scroll up and down through the list services in any suitable way. Following selection of one of the services via a user input 39, the mobile device acts on the service selection at step 40 to initiate consumption of the content of the corresponding service at step 41.

The content descriptor can be considered as a data item. Instead of there being an icon or other identifier stored in respect of each content descriptor, one may be stored in respect of a data item having a different representation. In one embodiment, the data item is a service identifier. Here, the icon data storage area 13 of FIG. 2 contains, in addition to an item of icon data for each content descriptor, icon data for each of one or more services. In this case, icons are linked to service identifiers, i.e. to an identifier which uniquely identifies a service or a service provider. Since a service provider may provide plural services, an icon linked to a service provider may relate to plural services.

When providing an ESG for display, the mobile device 1 gives priority to the service identifier icons. Accordingly, if for a given service there exists an icon relating to the content descriptor of that service and there also exists an icon specific to the service identifier, i.e. there is an icon for each of the service (or service provider) and the type of content that the service relates to, the icon for the service or service provider is displayed on the display 10 and the icon relating to the content descriptor is not displayed.

A more specific implementation of the invention will now be described by way of example with reference to FIGS. 5 and 6. This embodiment comprises a dual mode mobile telephone communications device capable of operating in a first mode through a cellular network such as GSM or UMTS, and in a second mode to receive DVB-T data transmissions. The circuits of such a device 50 are shown schematically in FIG. 5 and comprise an internal power supply in the form of a rechargeable battery 51, a micro-controller 52 which can operate as the combiner 11 of FIG. 1, the display 10, keyboard 53 which acts as the input device of FIG. 1 and memory 54 which provides the database storage areas 12, 13, 14 and 16 of FIG. 1.

In order to operate in the first, cellular telephony mode, the device includes an antenna 55, a transceiver 56, codec 57, and the usual microphone 58 and speaker 59 with associated amplifiers 60 and 61. As well known in the art, the telephony circuits operate under the control of the micro-controller and the keyboard 53 to make and receive calls over the air through the cellular network.

To operate in the second mode, the device 50 includes an antenna 62 to receive DVB-T broadcasts, tuneable receiver circuits 63 for parsing the received DVB signals and an associated codec 64. Services received through the DVB broadcasts are displayed under the control of micro-controller 52 on the display 10 and corresponding audio signals are fed to the speaker 59.

As previously explained, the DVB signals that convey service content data are transmitted in bursts using so called time-slicing in order to achieve reduced power consumption in the receiver of the mobile device 50. The ESG data is received in bursts in a channel to which the receiver 63 of the mobile device is tuned, and the ESG data received in one or more bursts in that channel is stored in the storage area 12 in the memory 54 of mobile device, with the receiver being turned off between the end of receiving one burst received and the start of receiving the next burst. The micro-controller 52 acts in the manner previously described with reference to FIG. 4 in order to render the stored ESG data and the associated icons according to the user preferences.

FIG. 6 illustrates an example of the display of the ESG data on the display device 10 according to one of the user content preferences. The display is rendered in a browser window 64. A first dialog box 65 of the window allows the user to set up the user preferences, which correspond to filters for the stored ESG data in the memory 54. The user preferences can be stored in the database area 16 for future use. A second dialog box 66 displays the data ESG data found in the database area 12 for selection by the user i.e. step 36 in FIG. 4. In this example, the user preference relates to World News & Sport and the available services that correspond to the user preference are displayed in dialog box 66, for selection by the user. A third dialog box 67 displays the description of a selected service or so-called session and provides instructions for accessing the session. A fourth section displays an icon 68 retrieved in step 38 of FIG. 4, which in this example is a globe associated with World News and Sport. In this example a single icon is appropriate for the user preference but in some instances more than one icon may be used. For example an individual icon may be associated with service session displayed in the dialog box 66.

The icons or other identifiers may be changed in different geographical areas especially as an identifier for a local service, or e.g. a hobby. Thus, the icon of the New York Rangers in New York area will disclose a service relating to hockey and the icon of Dallas Stars in Dallas area will also disclose a service relating to hockey. The local update for the icon or other identifier information need be provided through the cellular network or the DVB-T network only once when the user roams into a particular locality.

Also, the icons can be changed at different times, by way of an update but without the need to transmit icon data on a continuous basis. Also from the foregoing it will be understood that instead of an icon, other identifiers may be used including one or more of the following: a figure, a picture, a graphical symbol, an animation, a textual string, an audible signal or in fact any other user-recognizable feature that can be rendered by a suitable rendering means to be presented to the user.

The described embodiments are not intended to be limiting to the invention. Other embodiments will be apparent to those skilled in the art. The invention is limited only by the scope of the appended claims.

1. A method of operating a mobile device, the method
comprising: receiving service guide information;
extracting a data item for a service from service guide data relating to the service and included in the service guide information;
using the data item to retrieve from memory a pre-existing identifier associated with the data item; and
rendering the identifier along with at least some of the service guide data for the service.

2. A method as claimed in claim 1, wherein the identifier is one or more of the following: an icon, a figure, a picture, a graphical symbol, an animation, a textual string or an audible signal.

3. A method as claimed in claim 1 including receiving the service guide data in bursts, storing the service guide data received in one or more bursts and displaying the stored service guide data.

4. A method as claimed in claim 1, in which the using step involves comparing the data item with a further data item stored with the identifier, and retrieving the identifier if there is identicality.

5. A method as claimed in claim 1, comprising allowing a user to define what fields of the service guide data are displayed with the identifier.

6. A method as claimed in claim 1, comprising allowing a service provider to define what fields of the service guide data are displayed with the identifier.

7. A method as claimed in claim 1, comprising pre-installing the or each identifier on the mobile device.

8. A method as claimed in claim 1, comprising receiving the or each identifier separately of the service guide information.

9. A method as claimed in claim 1, wherein the data item is a service identifier.

10. A method as claimed in claim 1, wherein the data item is a content descriptor.

11. A method as claimed in claim 10, comprising storing in memory a user preference database, each of one or more entries in the user preference database linking a selectable preference with one or more content descriptors.

12. A method as claimed in claim 11, comprising, in response to the selection by a user of an identifier or service guide data relating to a service, initiating consumption of content associated with the service.

13. A method as claimed in claim 1, comprising, in response to the selection by a user of an identifier or service guide data relating to a service, initiating consumption of content associated with the service.

14. A mobile device, comprising:
a store for storing service guide information;
an extractor for extracting a data item for a service from service guide data relating to the service and included in the service guide information;
a retriever for using the data item to retrieve from memory a pre-existing identifier associated with the data item; and
a display for rendering the identifier along with at least some of the service guide data for the service.

15. A mobile device as claimed in claim 14, wherein the identifier is one or more of the following: an icon, a figure, a picture, a graphical symbol, an animation, a textual string or an audible signal.

16. A mobile device as claimed in claim 14, in which the retriever includes a comparator, for comparing the data item with a descriptor stored with the identifier, the retriever being arranged to retrieve the identifier if there is identicality.

17. A mobile device as claimed in claim 14, comprising a field identifier for allowing a user to define what fields of the service guide data are displayed with the identifier.

18. A mobile device as claimed in claim 14, comprising a field identifier for allowing a content provider to define what fields of the service guide data are displayed with the identifier.

19. A mobile device as claimed in claim 14, in which each identifier is pre-installed.

20. A mobile device as claimed in claim 14, comprising a receiver for receiving each identifier separately of the service guide information.

21. A mobile device as claimed in claim 14 in which the data item is a service identifier.

22. A mobile device as claimed in claim 14 in which the data item is a content descriptor.

23. A mobile device as claimed in claim 14, comprising a second store for storing a user preference database, each of one or more entries in the user preference database linking a selectable preference with one or more content descriptors.

24. A mobile device as claimed in claim 23, comprising a data display selector responsive to the selection by a user of a selectable preference for displaying service guide data relating only to services having the corresponding one or more content descriptors.

25. A mobile device as claimed in claim 14, comprising a consumption indicator responsive to the selection by a user of an identifier or service guide data relating to a service for initiating the consumption of content associated with the service.
